(19) United States
(12) Patent Application Publication
(10) Pub. No.: US 2019/0082138 A1
(43) Pub. Date: Mar. 14, 2019

(54) INVERSE TONE-MAPPING TO A VIRTUAL DISPLAY

(71) Applicant: Apple Inc., Cupertino, CA (US)

(72) Inventors: Hao Pan, Sunnyvale, CA (US); Munehiro Nakazato, San Jose, CA (US); Qiang Wang, Campbell, CA (US); Vaidyanath Mani, Los Altos, CA (US); Xiaohua Yang, San Jose, CA (US); Xin Wang, San Jose, CA (US); Xuemei Zhang, Mountain View, CA (US); Yingjun Bai, San Jose, CA (US)

(21) Appl. No.: 15/701,388

(22) Filed: Sep. 11, 2017

(51) Int. Cl. H04N 7/01; G06F 17/10

(52) U.S. Cl. CPC H04N 7/0117; G06F 17/10; H04N 7/0125

(57) ABSTRACT

Techniques for adjusting formats of images and video are presented, for example where an SDR source is presented on an HDR display, or vice versa. Techniques include deriving a conversion profile for image data where the conversion profile is responsive to parameters describing characteristics of a domain of source image data and characteristics of a domain of a target rendering environment. Some techniques include creating a tone curve from weighted basis functions.

### BACKGROUND

Digital imaging generally involves an image source, such as a camera to capture an image or video of a natural scene, a digital representation of captured source video, and a display for reproducing the video for a viewer. Each stage of a digital imaging system, including source, representation, and display, have imaging parameters, including limitations, for the types of images they can produce, represent, or display. For example, each image source, representation, and display can support a certain dynamic range of brightness, from darkest to brightest, and can support only a certain color gamut. When a source, representation, and display in an image processing system do not have matching parameters, a conversion process may be required.

High-dynamic range (HDR) video has become common in some video systems, including cameras capable of capturing HDR video, HDR digital image representations, and HDR displays. HDR video can be compared to standard dynamic range (SDR) video system. HDR images or videos have a wider dynamic range of luminosity, as compared to traditional SDR images or videos. HDR enables capturing (or representing in a data format, or displaying) scenes, for example, with both a very bright region, such as a bright sun-lite sky, and a dark region, while preserving image details in both bright and dark regions.

Generally, a need for improvement is perceived in systems where imaging parameters such as dynamic range may vary between the stages of an imaging system.

### BRIEF DESCRIPTION OF THE DRAWINGS

FIG. 1 depicts an example digital imaging environment.

FIG. 2 depicts an example system for adjusting video.

FIG. 3 depicts an example method for adjusting video.

FIG. 4 depicts an example method for adjusting video.

FIG. 5 illustrates an exemplary computer system 500 that may perform such techniques.

### DETAILED DESCRIPTION

This disclosure provides techniques for adjusting image data for a virtual display. When HDR images or videos are captured and have to be displayed on an SDR display, then dynamic range compression may be needed. Conversely, if SDR images or videos are to be displayed on an HDR display, then dynamic range expansion may be needed. By adjusting video into an intermediate format for a virtual display, consistent viewing experiences may be enabled on a real physical display. Embodiments include determining a tone curve based on imaging parameters of a source representation and a virtual display, and then adjusting source video to an intermediate format with the tone curve. Intermediate format video data can then be formatted for any particular final target display. In some embodiments, tone curves for adjustment of chroma data to the virtual display may be derived from a luma tone curve.

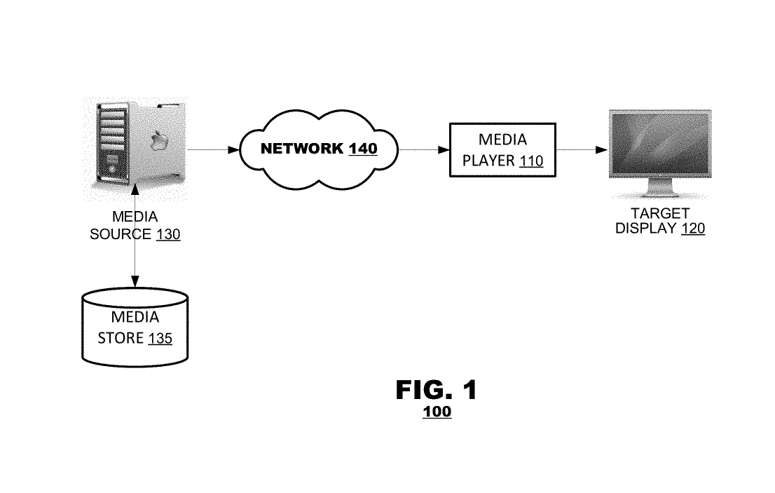

FIG. 1 depicts an example digital imaging environment. A media source 130 may include a media store 135 of source images. Media source 130 may be connected by a network 140 to a media player 110, which is further connected or integrated with a target display 120. In some embodiments, video images may be streamed from the media source through the network and rendered by media player 110 on the target display 120.

If imaging parameters do not match between the media source 130 and the target display 120, a conversion process may be performed. Many target displays include the ability to accept more than one format of input video, and then convert the accepted formats as necessary to accommodate the target display's native physical imaging parameters. However, format conversion inside the media player may be advantageous for several reasons. The format conversion techniques within a target display may be of poor quality, or a delay may be incurred by the target display when the imaging parameters of a video source change. For example, a source media item may have been generated according to several source representations, which may change at various points during rendering of a media item. When a switch between different representations occurs, a target display, which is designed for real time rendering of media content, may incur a delay, such as up to several seconds, before presenting video with the new imaging parameters. Such a delay while switching between different imaging parameters may cause a poor viewer experience, such as a momentary blank screen or a reset of a viewer's custom settings. In some cases, a target display may not be able to detect changes in source video, requiring a viewer to intervene by manually changing conversion settings.

Format conversion at media player 110 may also be advantageous to enable blending of imaging sources at the media player where the blended image sources have different imaging parameters. For example, media player 110 may have a graphical user interface that is synthetically rendered by the media player and composited into images from media source 130 for a combined presentation at target display 120. Alternately, two separate media sources may be combined with a picture-in-picture effect at the media player. A format conversion at the media player may be necessary to blend or composite images at the media player where the different sources have different imaging parameters.

Media player 110 may convert any video source data to conform to imaging parameters of a hypothetical virtual display for later consumption by target display 120. The imaging parameters of the virtual display may be selected to be a superset of possible imaging parameters of possible media sources, and may be selected to be a superset of possible target displays. For example, a virtual display may be selected to have a dynamic range as great, a color gamut as wide, and a sample precision as high as the largest, widest, and highest of any possible sources and target displays. In one example, source media in 8-bit SDR format may be converted to a virtual display having imaging parameters that match HDR with 10-bit precision.

For example, a source video with a maximum brightness of 150 nits could be displayed on a target display with a brightness of 300 nits. A brute-force mapping, where a source pixel of brightest possible value representing 150 nits is presented on a target display at the target display at 300 nits, would result in brightening the source image. A conversion of the source image with a tone curve that, for example, maps source image brightness non-linearly to a virtual display, may better preserve the look of the original source image. A conversion to a virtual display with one or more tone curves may prevent brightening an image or supersaturating colors. As display technology improves and target displays become capable of presenting even brighter images with larger color gamuts, the potential for distorting source images may grow.

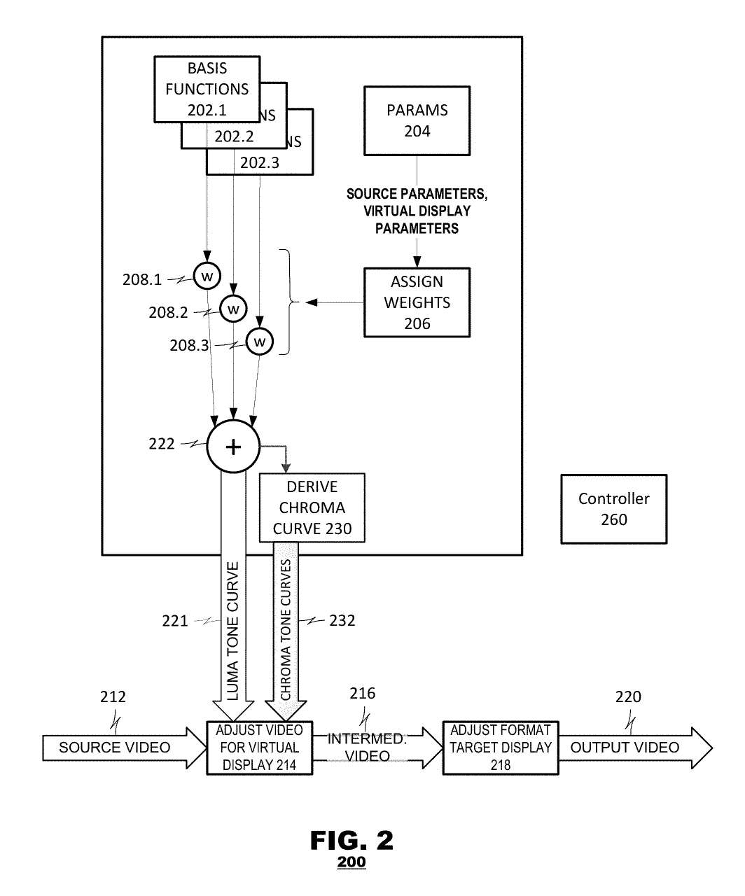

FIG. 2 depicts an example system for adjusting video. A collection of basis functions, 202.1, 202.2, and 202.3, may be combined to produce one or more tone curves for mapping source video 212 to a virtual display. Parameters 204 of source video and a virtual display may be used in box 206 to assign weights 208.1-208.3 to the basis functions 202.1-202.3. The weighted basis functions may be combined in 222 to produce a luma tone curve 221. One or more chroma tone curves 232 may be derived in box 203 from the luma tone curve produced in 222. Tone curves 221 and 232 may then be used in box 214 to adjust source video 212 into intermediate video 216 for a virtual display. Intermediate video 216 may be format adjusted for a target display in box 218 to produce output video 220, which may be sent to a target display. Parts or all of the video adjustment process may be performed or controlled by controller 260. In some embodiments, controller 260 may include one or more computer processors executing software instructions stored in a computer memory.

Parameters 204 may include imaging parameters such as a white point and a black point of source video or a virtual display. In some embodiments, parameters may also include data such as the ambient light measured or estimated in the environment around or outside a particular target display. Parameters 204 may also specify the display technology used in a particular target display.

Tone curve basis functions 202.1-202.3 may be predetermined, for example based on perceptual modeling of a human visual system, including models of human perceived change in brightness or color. Parameters 204 may include imaging parameters of the source video and imaging parameters of a virtual display. In some cases, imaging parameters of a virtual display may be determined based on the imaging parameters of a specific known target display or based on a collection of possible target displays. Weights may be assigned in box 206, for example, by selecting a predetermined matrix of weights for basis functions based on, for example, a white point and black point of the source video, and based on the white point and black point of the virtual display. Alternately, weights may be assigned in box 206 as an algorithmic function of parameters 204.

Luma tone curve may be created by combining in 222 the basis functions 202.1-202.3 weighted by 208.1-208.3. In other embodiments, different numbers of basis functions and weights may be used, for example, more or less than three basis functions. The combining operation of 222 may be performed by piecewise addition of the weighted basis functions. In other embodiments, the combining operation of 222 may produce a sum of the weighted basis functions input to 222.

A tone curve, such as the luma tone curve 221 or chroma tone curves 232, may function to map a single input scalar value to an output scalar value. For example, luma tone curve 221 may map the luma value of a source pixel to a luma value in the virtual display domain. Similarly, a first chroma tone curve may map a first chroma value of a source pixel to a first chroma value of the virtual display. A tone curve may be implemented, for example, as a look-up-table (LUT), or may be implemented as an algorithmic function such as a piece-wise linear function.

In some embodiments, the imaging parameters of the virtual display may be determined based on parameters of a particular target display, and the format adjustment in box 214 may include adjustments to pixel data related to a particular target display. For example, adjustments to source pixel data may be made in box 214 that account for a measured or estimated ambient light at a target display, and may include an adjustment based on the display type of the target display. A display type of a target display may include specification of a physical display technology such as CRT, LCD, or OLED. Adjustments to source data based on a particular target display may be made after application of tone curves. Alternately, adjustments to source data based on a particular target display may be made by selecting different weighting of basis functions in box 206, or by modifying the basis functions 202.1-202.3.

Format adjustment in box 218 may involve data packaging changes, such as altering or creating image header information, and inserting metadata. In contrast with box 214, which may change the value or relationship of pixel data such as non-linear mappings of pixel values, box 218 may create or change image metadata, or change the organization of pixel data, without changing pixel values. In some embodiments, data about the image adjustments of box 214 may be added as metadata to the output video 220, for example in the format adjustment of box 218. Such added metadata may include specification of some or all of the parameters 204, the weights 206, the basis functions 202.1-202.3, the luma tone curve 221 and/or the chroma tone curve 232.

In alternate embodiments, a conversion profile for converting source image data may be derived from parameters describing characteristics of a domain of source image data and characteristics of a domain of a target rendering environment. Source image data may be converted according to the conversion profile, and then output to a target display or rendering environment. For example, the conversion profile may be derived from a stored library of basis functions, where contribution of individual basis functions may be weighted according to the characteristics of the source image domain and the target rendering domain.

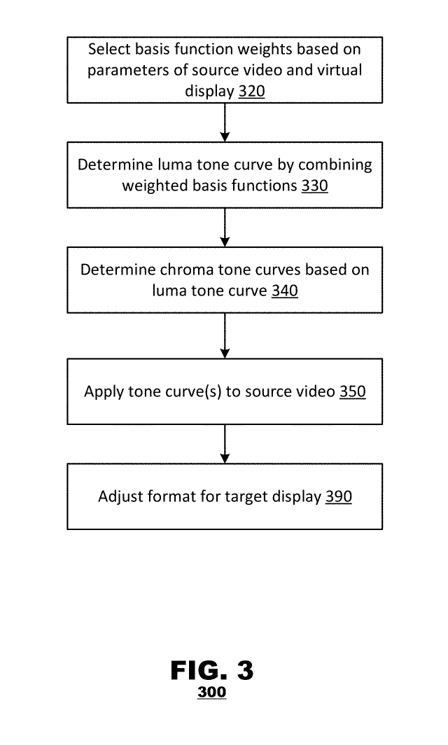

FIG. 3 depicts an example method for adjusting video. In box 320, weights are assigned to basis function based on parameters of source video and parameters of a virtual display. A luma tone curve may be determined by combining the weighted basis functions in box 330, and then one or more chroma tone curves may be determined based on the luma tone curve in box 340. Source video may be adjusted for a virtual display by applying the determined tone curves in box 350. In box 390, video data formatted for the virtual display is format-adjusted for a particular target display.

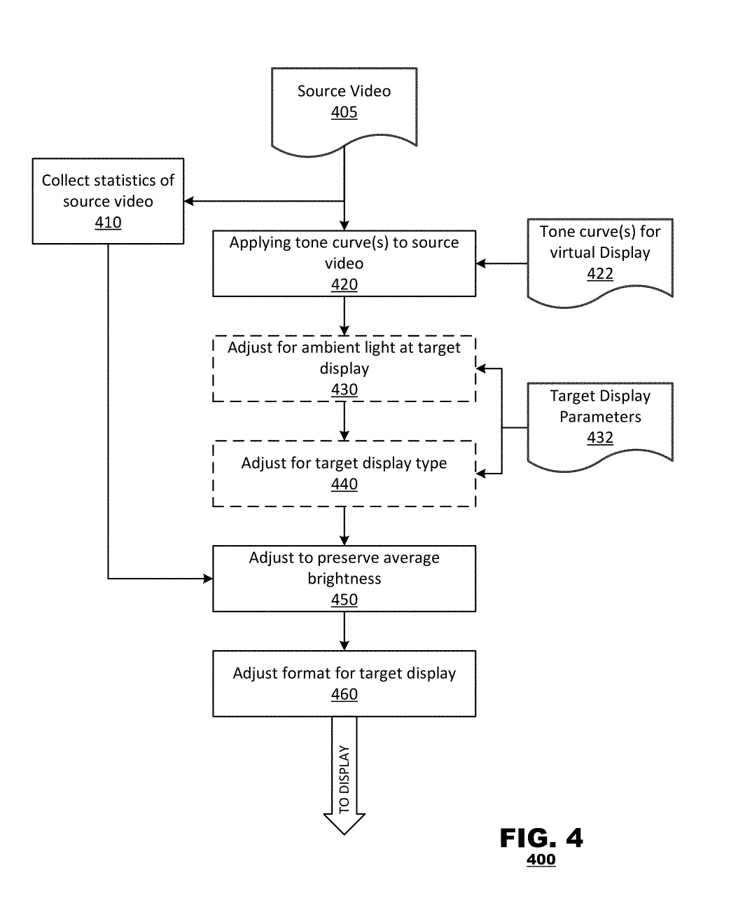

FIG. 4 depicts an example method for adjusting video. Source video data 405 may be adjusted for a virtual display in box 420 with one or more tone curves 422. Tone curve 422 may be determined, for example, with the system of FIG. 2 or methods of FIG. 3. Based on target display parameters 432, an optional adjustment for the ambient light at the target display may be done in box 430, and an optional adjustment for target display physical technology may be done in box 440. Statistics of a portion of source video 405 data may be collected in box 410, such as the average brightness of a frame or scene, or a histogram of brightness distribution of pixel data for a portion of source video. Certain statistical properties may then be preserved, for example by an adjustment in box 450 to preserve an average brightness of the portion of source video for which statistics were collected in box 410. In box 460, a final formatting adjustment for a target display may be done in box 460 before sending video data to a target display, as described above regarding box 218 of FIG. 2.

In other embodiments, adjustments for ambient light and display type may be made by adjusting one or more tone curves before applying the tone curves, in contrast to the adjustments for ambient light and display type depicted in FIG. 4. For example, after determining a luma tone curve in 222 of FIG. 2 or box 330 of FIG. 3, the luma tone curve may be adjusted based on an estimated ambient light at a target display, and/or the luma tone curve may be adjusted based on the display type of a target display. After adjusting the luma tone curve, it may then be applied to source image data as in box 420 of FIG. 4.

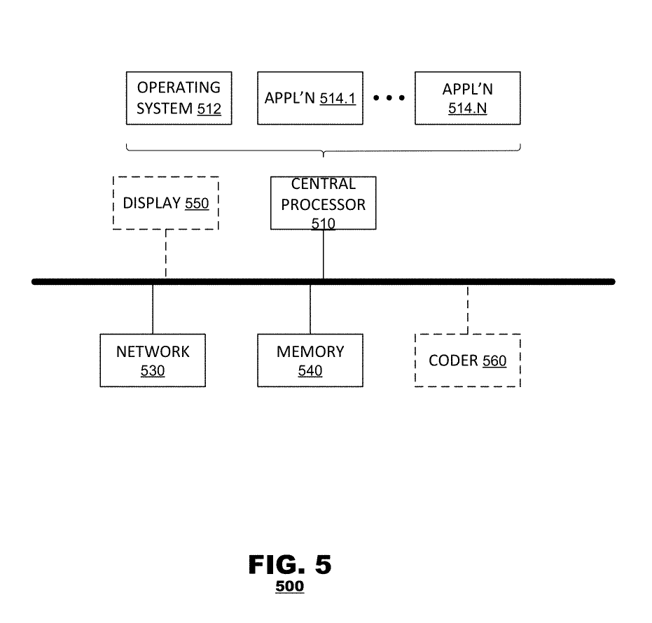

In an embodiment, the image adjustment techniques described herein may be performed by a central processor of a computer system. FIG. 5 illustrates an exemplary computer system 500 that may perform such techniques. The computer system 500 may include a central processor 810, a network interface 530, and a memory 540 may be in communication with one another. Source images and video may be received via network interface 530, and be stored stored in memory 540. Optionally, the device also may include a display 550 and an image or video coder 560.

The central processor 510 may read and execute various program instructions stored in the memory 540 that define an operating system 512 of the system 500 and various applications 514.1-514.N. The program instructions may perform image processing according to the techniques described herein. As it executes those program instructions, the central processor 510 may read from the memory 540 the image data received by network interface 530, and it may generate tone curves and adjust the received source images as described hereinabove. The memory 540 may store the program instructions on electrical-, magnetic- and/or optically-based storage media.

The controller 260 of FIG. 2 and the methods of FIGS. 3 and 4 may be provided in a variety of implementations. They can be embodied in integrated circuits, such as application specific integrated circuits, field programmable gate arrays, digital signal processors and/or general-purpose processors.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

1. A method for converting source video data, comprising:
selecting basis function weights based on imaging parameters of the source video and imaging parameters of a virtual display;
applying the selected basis function weights to tone curve basis functions retrieved from a stored library of basis functions;
determining a luma tone curve by combining the weighted tone curve basis functions;
applying the tone curve to source video data to create virtual-display-formatted video data; and
outputting the virtual-display-formatted video data to a display device.

2. The method of claim 1, further comprising:
determining the imaging parameters of the virtual display based on parameters of a target display.

3. The method of claim 1, further comprising:
determining a chroma tone curve based on the luma tone curve;
applying the chroma tone curve to the source video data.

4. The method of claim 1, further comprising:
adjusting the virtual-display-formatted video data for a target display based on parameters of the target display.

5. The method of claim 1, further comprising:
adjusting the virtual-display-formatted video data based on an amount of ambient light at a target display.

6. The method of claim 1, further comprising:
adjusting the virtual-display-formatted video data based on a target display type.

7. The method of claim 1, further comprising:
estimating an average brightness of a portion of source video data;
adjusting a portion of the virtual-display-formatted video data to preserve the average brightness.

8. The method of claim 1, wherein the selection of weights is based on a source video format white and black points and a virtual display white and black points.

9. A method, comprising:
responsive to parameters describing characteristics of a domain of source image data and characteristics of a domain of a target rendering environment, selecting weights according to the characteristics of the source image domain and the target rendering domain;
deriving a conversion profile for image data by applying the selected weights to tone curve basis functions,
converting source image data according to the conversion profile to a virtual display domain, and
outputting converted source image data in the virtual display domain to a target rendering device.

10. The method of claim 9, further comprising:
estimating an average brightness of a portion of source video data;
adjusting converted source image data to preserve the average brightness.

11. The method of claim 9, further comprising:
determining a luma tone curve; and
deriving a chroma tone curve from the luma tone curve.

12. The method of claim 9, wherein the the tone curve basis functions are stored in a library of basis functions.

13. The method of claim 12, wherein the weighting of individual basis functions are based on white point and black point characteristics of the domain of source image data and white point and black point characteristics of the domain of the target rendering environment.

14. A system comprising a computer processor and memory, the memory containing instructions that, when executed by the computer processor, cause at least:
responsive to parameters describing characteristics of a domain of source image data and characteristics of a domain of a target rendering environment, selecting weights according to the characteristics of the source image domain and the target rendering domain;
deriving a conversion profile for image data representing a conversion of the source image data to a virtual display domain by applying the selected weights to tone curve basis functions,
converting source image data according to the conversion profile to the virtual display domain, and
outputting converted source image data in the virtual display domain to a target rendering device.

15. The system of claim 14, wherein the instructions further cause:
estimating an average brightness of a portion of source video data;
adjusting converted source image data to preserve the average brightness.

16. The system of claim 14, wherein the instructions further cause:
determining a luma tone curve; and
deriving a chroma tone curve from the luma tone curve.

17. The system of claim 14, wherein the the tone curve basis functions are stored in a library of basis functions.

18. The system of claim 17, wherein the weighting of individual basis functions are based on white point and black point characteristics of the domain of source image data and white point and black point characteristics of the domain of the target rendering environment.

19. A non-transitory computer readable medium comprising instructions that when executed by a processor cause at least:
responsive to parameters describing characteristics of a domain of source image data and characteristics of a domain of a target rendering environment, selecting weights according to the characteristics of the source image domain and the target rendering domain;
deriving a conversion profile for image data representing a conversion of the source image data to a virtual display domain by applying the selected weights to tone curve basis functions,
converting source image data according to the conversion profile to the virtual display domain, and
outputting converted source image data to a display.

20. The medium of claim 19, further comprising:
estimating an average brightness of a portion of source video data;
adjusting converted source image data to preserve the average brightness.

21. The method of claim 9, wherein the derivation of the conversion profile comprises:
selecting weights based on the characteristics of the source image data domain and the target rendering environment domain;
applying the selected weights to basis functions retrieved from a stored library of basis functions.
